(19) United States
(12) Patent Application Publication
(10) Pub. No.: US 2018/0139821 A1
(43) Pub. Date: May 17, 2018

(54) METHOD AND APPARATUS FOR AUTONOMOUS LIGHTING CONTROL

(71) Applicant: GENERAL ELECTRIC COMPANY, Schenectady, NY (US)

(72) Inventors: Anirudha R. DESHPANDE, Cleveland Heights, OH (US); Thomas CLYNNE, East Cleveland, OH (US); Koushik Babi SAHA, Strongsville, OH (US); Jonathan Robert MEYER, Shaker Heights, OH (US)

(21) Appl. No.: 15/475,849

(22) Filed: Mar. 31, 2017

Related U.S. Application Data
(60) Provisional application No. 62/421,834, filed on Nov. 14, 2016.

(51) Int. Cl. H05B 37/02

(52) U.S. Cl. CPC H05B 37/0227; F21S 8/086; H05B 37/0236; H05B 37/0272

(57) ABSTRACT

There are provided methods and apparatuses for autonomous lighting control. For example, there is provided a lighting system that includes a first node associated with a first lighting fixture and a second node associated with a second lighting fixture. The first node may be communicatively coupled to a sensor. Further, the first node may be configured to fetch or receive data from the sensor, and, based on the data, the first node may communicate a command to the second node. The command may include an instruction to alter a light output at the second lighting fixture.

### CROSS-REFERENCE TO RELATED APPLICATIONS

The present disclosure claims the benefit of U.S. Provisional Patent Application No. 62/421,834 filed on Nov. 14, 2016, the content of which is incorporated herein by reference in its entirety.

### TECHNICAL FIELD

The present disclosure relates to lighting control. More particularly, the present disclosure relates to methods and apparatuses for providing autonomous lighting control.

### BACKGROUND

Artificial lighting is ubiquitous and has become an integral part of our environment and society. There are billions of light sockets and millions of standalone fixtures used indoor and outdoor, and in most circumstances, these sockets and fixtures are controlled by merely turning a power supply on or off. In some applications, however, there can be an additional dimension for controlling a lighting fixture by adjusting the amount of light output from the fixture. This can be done in a variety of ways, including varying the amount of power delivered to the lighting element within the fixture.

Furthermore, some lighting fixtures include individual light sources that can provide a variety of light output patterns by utilizing beam forming optics such as reflective and/or refractive optical elements. Light output patterns may also be varied by altering the orientation of the light emanating from the light source itself. As such, controlling a single or multiple of these light source/optics combinations can yield a desired light distribution from the lighting fixture as a whole.

Methods for initiating the control of lighting fixtures arranged in a lighting system network generally include hardwiring control means directly to the power supply of the lighting fixtures included in the network. In one typical scenario, these hardwiring methods require varying the power light sources in accordance with a control signal protocol associated with a controller that is locally installed at the lighting fixture. For example, such a control signal protocol may be based on a standard 0 to 10 Volt signaling controller, or on a DALI signaling protocol. Such methods can be cumbersome when a large number of lighting fixtures must be controlled.

In yet another scenario, a wireless link can be established to a control device within the fixture via a standard communications protocol such as Wi-Fi or via other known communications methods. These methods generally require the establishment of a larger control architecture, including access to a large communications network, such as the Internet, which is utilized to provide the actual command and control signals for the lighting network from a remote location. As such, these methods can be cost-prohibitive over large geographic areas.

### SUMMARY

The embodiments featured herein provide autonomous sensing of environmental conditions surrounding a lighting fixture and the capability of performing adjustments to the output of one or more lighting fixtures in response to the sensed conditions. Further, some of the embodiments may be used to provide a large area command and control lighting system that is autonomous and free of the drawbacks of typical lighting systems networks. Furthermore, some of the embodiments may be configured to accumulate operational information regarding the performance and sensed conditions throughout a large area, thus providing data for use as a learning database for future system deployments and/or for further analytics and control method development.

One embodiment provides a lighting system that includes a first node associated with a first lighting fixture and a second node associated with a second lighting fixture. The first node may be communicatively coupled to a sensor. Further, the first node may be configured to fetch or receive data from the sensor, and, based on the data, the first node may communicate a command to the second node. The command may include an instruction to alter a light output at the second lighting fixture.

Another embodiment provides a method for use with a set of lighting fixtures. The method includes autonomously altering a light output of a first lighting fixture of the set. The autonomous altering includes receiving sensor information by a node associated with a second lighting fixture of the set. The autonomous altering further includes communicating to a node associated with the first lighting fixture, based on the sensor information, a message configured to cause a power controller of the first lighting fixture to alter the light output at the first lighting fixture.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a lighting system according to several aspects described herein.

FIG. 2 illustrates a lighting system according to several aspects described herein.

FIG. 3 illustrates a lighting fixture according to several aspects described herein.

FIG. 4 illustrates a block diagram of a response controller according to several aspects described herein.

FIG. 5 illustrates a block diagram of an intelligent control node according to several aspects described herein.

FIG. 6 illustrates a lighting control system according to several aspects described herein.

FIG. 7 depicts a flow chart of a method for autonomous lighting control according to several aspects described herein.

FIG. 8 depicts a flow chart of a method for autonomous lighting control according to several aspects described herein.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

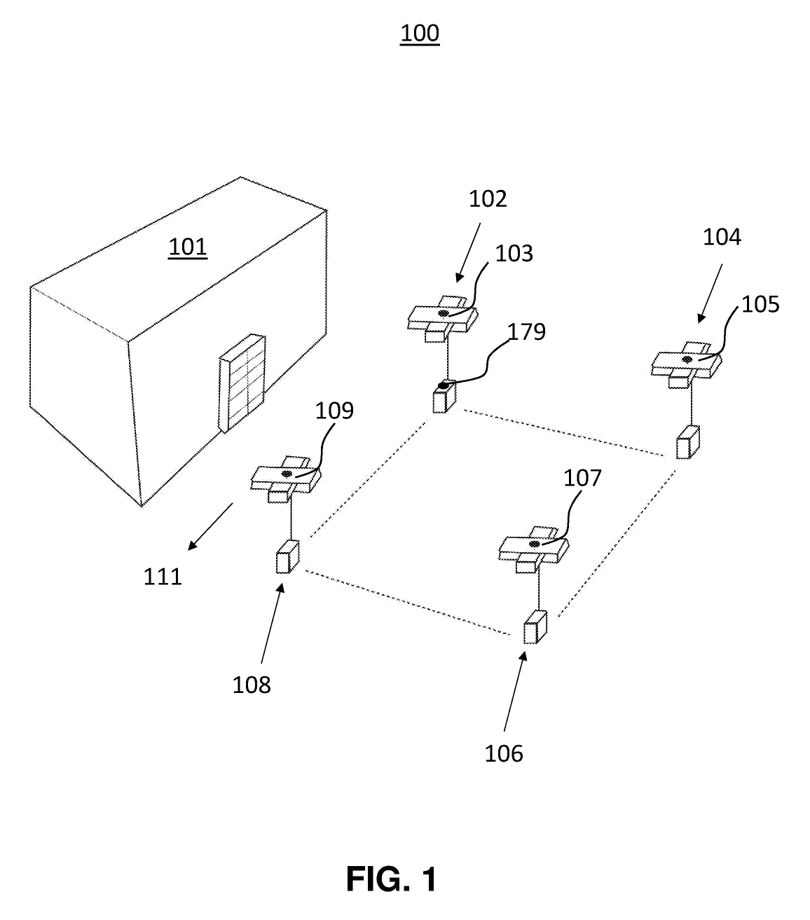

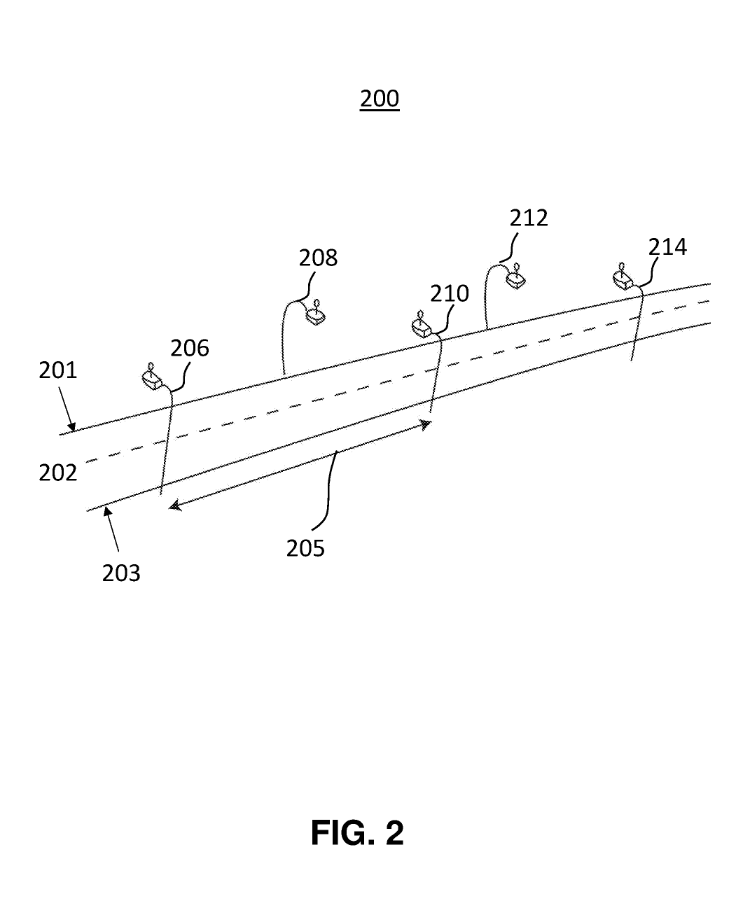

FIGS. 1 and 2 each illustrates exemplary lighting systems (100 and 200, respectively) according to two embodiments. For example, the lighting system 100 includes a network of lighting fixtures (102, 104, 106, and 108) that are arranged in parking lot of a building 101. The lighting fixtures 102, 104, 106, and 108 are equipped with nodes 103, 105, 107, and 109, respectively, and each of the aforementioned nodes may or may not be communicatively coupled to the other three remaining nodes.

In one embodiment, among the nodes 103, 105, 107, and 109 there can be one or more intelligent or “smart” nodes while the other remaining nodes may be thought of as “dumb” nodes. For example, in one exemplary embodiment, the node 103 may be an intelligent node, while the nodes 105, 107, and 109 are the dumb nodes.

An intelligent node is communicatively coupled to one or more sensors associated with the lighting fixture to which it is attached or to one or more sensors. The one or more sensors may be co-located with the associated lighting fixture, or they may be disposed elsewhere in the lighting system 100. For example, a sensor may be a camera that is located directly at that the lighting fixture 102. Alternatively, the camera may be located elsewhere, such as on top of the building 101 for example, or even on the lighting fixture 106.

The one or more sensors may be selected from the group consisting of a video camera, an acoustic sensor, a thermometer, a pressure sensor, a humidity sensor, a lightning detector, an accelerometer, a rate gyroscope, a passive infrared (PIR) detector, a radar, an ultrasonic sensor and a thermal imaging sensor/camera system. Nevertheless, one of ordinary skill in the art will readily recognize that additional or other sensors than those listed may be used without departing from the scope of the present disclosure.

The intelligent node (in this case the node 103) includes one or more processors that can fetch or receive and decode data from the one or more sensors, and based on the data, the intelligent node may broadcast control signals that are configured to cause processors at the other nodes in the lighting systems 100 to cause their associated lighting fixtures to alter their respective light outputs. Such alterations in light outputs can include, for example, and not by limitation, dimming or brightening.

Furthermore, a dumb node may be a response controller node (105, 107, and 109) that can fetch or receive data from the intelligent control node, and based on the data, the response controller node may cause its associated lighting fixture to alter their light output as described above. In sum, a response controller node does not issue commands to its associated lighting fixture based on sensory data but rather based on commands received or fetched from the intelligent control nodes. In a given lighting system such as the lighting system 100, there may be one intelligent node that is communicatively to one or more sensors and to one or more response controller nodes.

The lighting system 200 is similar to the lighting system 100 with the difference that it includes a plurality of lighting fixtures (206, 208, 210, 212, and 214) disposed on a first side 201 and a second side 203 of a roadway 202. The lighting fixtures are separated by a distance 205.

In the lighting system 200, there may be more or fewer than five lighting fixtures as shown in FIG. 2. In other words, an exemplary lighting system 200 may include lighting fixtures that are disposed along a roadway that extends one or more miles. Each of the lighting fixtures in the lighting system 200 may have a node associated with it, and in the lighting system 200 one node may be configured as an intelligent control node while the remaining nodes are configured as response controller nodes. As shall be seen below, the embodiments provide several advantages that allow the lighting system 200 to extend over a large geographic areas in contrast to the lighting system 100, which is confined to a parking lot.

In one example application, for the case of the lighting system 100, the intelligent node (e.g., the node 103) receives traffic data from the passage way 111 from a sensor 179. The node 103 may then process the received data by extracting a measured traffic from the data, for example, and compare the measured traffic with a threshold saved in a memory associated with the node 103.

In one example, in response to the measured traffic exceeding the threshold, the node 103 may then broadcast a message to the response controller nodes 105, 107, and 109. The message may include a command that causes the respective power controllers of the lighting fixtures associated with the response controller nodes 105, 107, and 109 to alter the intensity of the light output of each fixture. Similarly, the lighting system 200 may include a single intelligent node that instructs response controller nodes to cause a change at their respective lighting fixtures in response to a sensed traffic (for example).

Within a typical fixture network, there exist standard interfaces and command sequences to regulate the power to a fixture. One of these is known as Digital Addressable Lighting Interface, or DALI for short. DALI is a standard binary protocol that has been established to enable individual and group level control over lighting fixtures that are connected to a common set of hardwired data lines via an addressing identification scheme. In the embodiments, the response controller nodes may incorporate a standard lighting interface, such as DALI, in order to effectively “translate” the command which they receive wirelessly into a data structure or control means which is recognized by lighting products.

While the embodiments featured herein are described in the context of the DALI protocol, the DALI protocol is not the only protocol that may be used with the embodiments. Specifically, one of ordinary skill in the art will readily recognize that the teachings featured herein may be adapted to other communication and protocols associated with lighting fixtures.

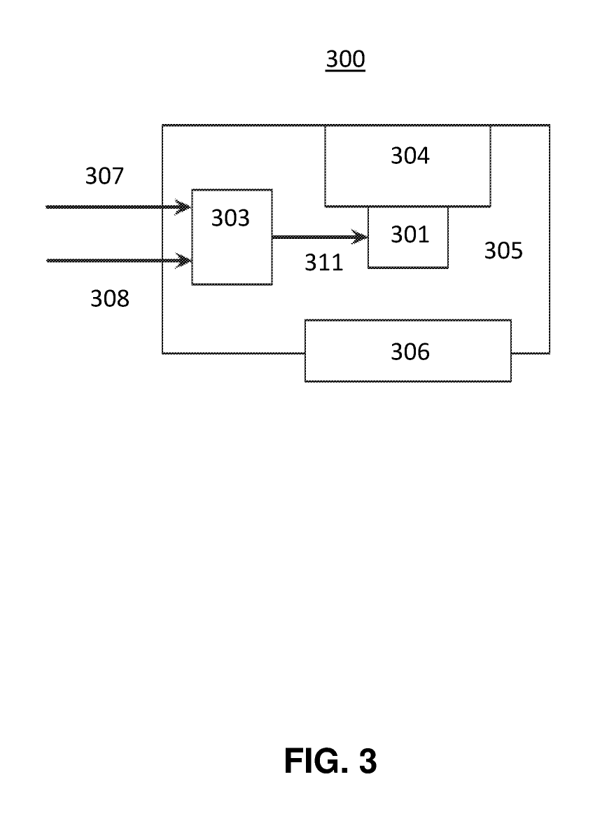

FIG. 3 depicts a block diagram of a typical DALI dimmable lighting fixture 300 in accordance with one embodiment. The fixture includes a light source 301 mounted to a heat sink 304 that provides cooling for the light source 301. The light source 301 is connected to its DALI Dimmable Driver 303 by individual wires 311. The DALI dimmable driver 303 can be considered to be the power supply for the light source 301, and it is supplied with AC power via a wire 307, which serves as a primary means for receiving external power.

The DALI dimmable driver 303 is also interfaced with control wires 308 that are connected to a source that supplies a DALI control signal, which may be generated based on an instruction received from a response controller node associated with the lighting fixture 300. The aforementioned components may be enclosed within a housing 305, which can also include a window 306 that provides environmental protection for the parts of the system while allowing light to emanate from the lighting fixture 300.

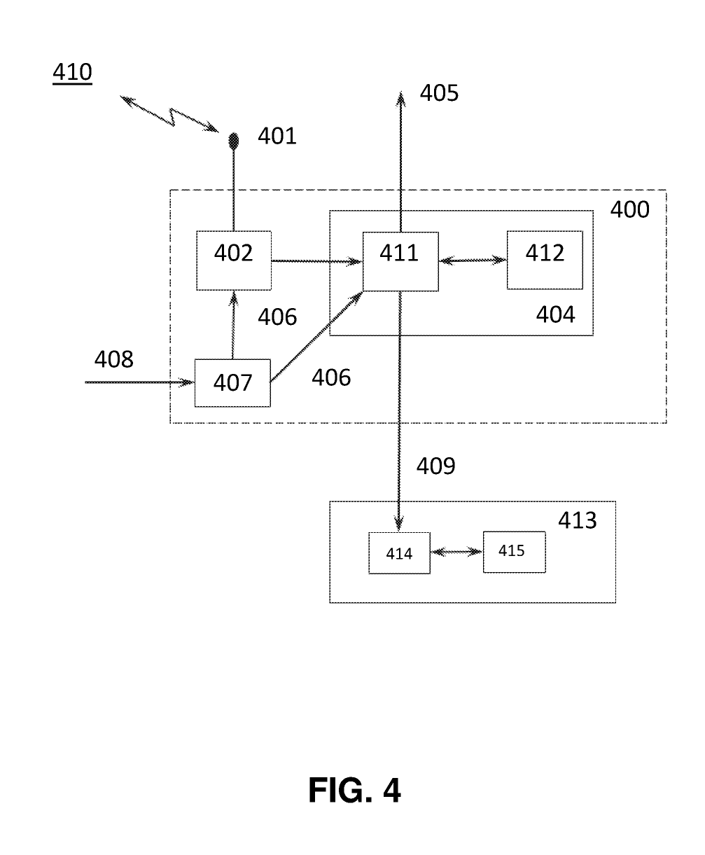

FIG. 4 depicts a block diagram of an embodiment of a response controller node 400. The response controller node 400 may include a radio modules 402, which has an antenna 401 that is configured to communicate with devices in a larger network 410. The radio module 402 may include an interface electronics 404 that includes a processor 411 and an interconnected memory 412 for the non-volatile storage of a program instruction set or for interim volatile storage for the results of computations within the processor 411. The interface electronics can have a control port 405 which can communicate with other portions of the system.

The output of the interface electronics 404 is configured to receive a set of DALI control signals provided on DALI wires 409 to a suitable DALI fixture 413, which in turn comprises a DALI-configured driver 414 and a corresponding light source 415. The node 400 may also comprise an AC to DC converter 407 which converts standard AC power 408 into DC voltage for the proper operation of the electronics within the node. The converter 407 is interconnected to those components in the node, which requires power via the DC power wires 406.

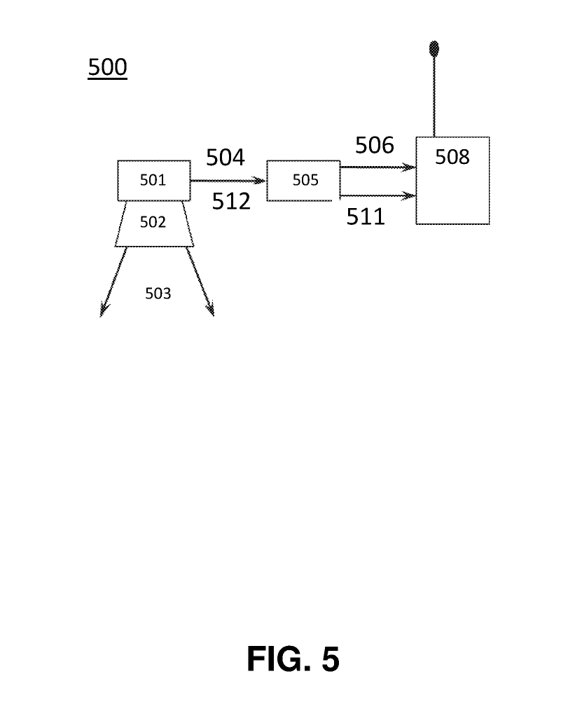

FIG. 5 depicts a block diagram of an embodiment of an intelligent lighting control node 500. In one example, this node comprises a camera 501 with a lens 502 that has a corresponding field of view 503. The camera 501 may be connected to a single board computer 505 via a control cable 504 through which pass control signals, power and data 512. The output of the single board computer 505 is a set of control signals provided to a response controller node 508 via control wires 506. There is also DC power supplied by the response controller node 508 to the single board computer 505 via DC power wires 511.

It is noted that as described in further detail below, the intelligent control node 500 may be in communication with one or more sensors that are not a camera. Generally, the control node 500 may use environmental sensors to sense one or more conditions in the environment of the control node 500. For example, the sensors may be either one of or a combination of an acoustic sensor, a thermometer, a pressure sensor, a humidity sensor, a lightning detector, an accelerometer, a rate gyro, a PIR detector, a radar, an ultrasonic sensor or a thermal imaging sensor/camera system.

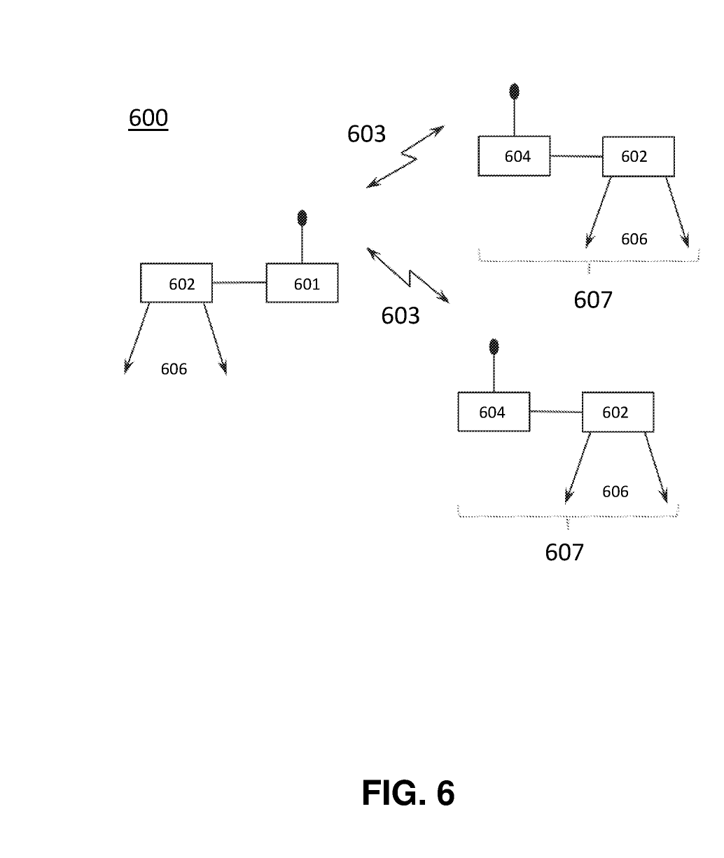

FIG. 6 depicts a typical embodiment of an autonomous lighting control system 600. The system comprises intelligent control node 601 which is interconnected to a DALI controlled fixture 602. This intelligent control node 601 senses its surroundings via the camera/lens combination 501 and 502 of FIG. 3 and determines if conditions have been met to effect a change in the light output 606 of the fixture 602. If the prerequisite conditions have been met, the intelligent control node 601 supplies signals to its interconnected fixture 602 and also transmits a wireless signal 603 to a plurality of other remote fixtures 607, equipped with response controllers 604. The remote fixtures 607 each includes a response controller 606 which is interconnected to the DALI controlled lighting fixture 602 and has a light output 606 which is affected by the signal 603 received from the intelligent control node 601.

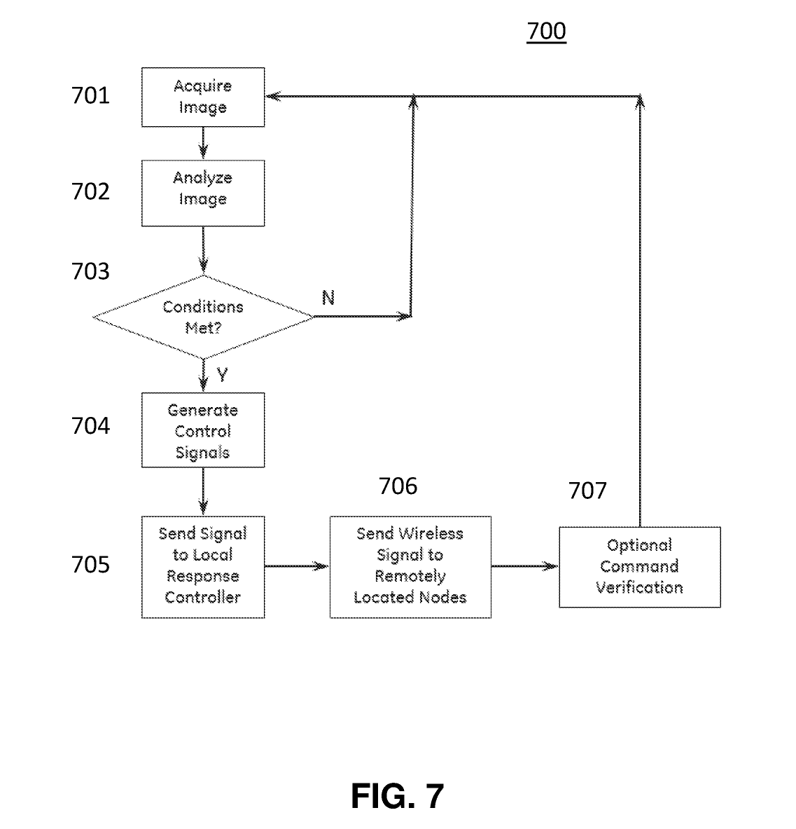

FIG. 7 depicts a flow chart of an exemplary method 700 of operation for the system. The method may comprise the following-described steps. A step to acquire an image 701 is performed and is analyzed in step 702. A decision is made at step 703 to determine if any prerequisite conditions have been met as a result of the analysis from step 702, and if they have not, the system continues to acquire images in step 701 until such conditions have been met. Once a condition has been met, the system will then generate control signals 706 at step 704 for its local DALI controller and effect the output of its host lighting fixture, as well as generate wireless control signals 706 for transmission to a remotely located fixture which has been equipped with a response controller (step 705).

The system can optionally be equipped with a handshaking and command verification step 707 to ensure that the fixture being commanded has actually received the command and taken the requested action. It is understood that further steps may be involved if the system comprises a plurality of remotely located fixtures and that the addressing schemes and command verification protocols become repetitive and introduce many other optional paths for the logic flow to follow. The sequence displayed is meant to simplify the demonstration of how the system may operate in a normal fashion.

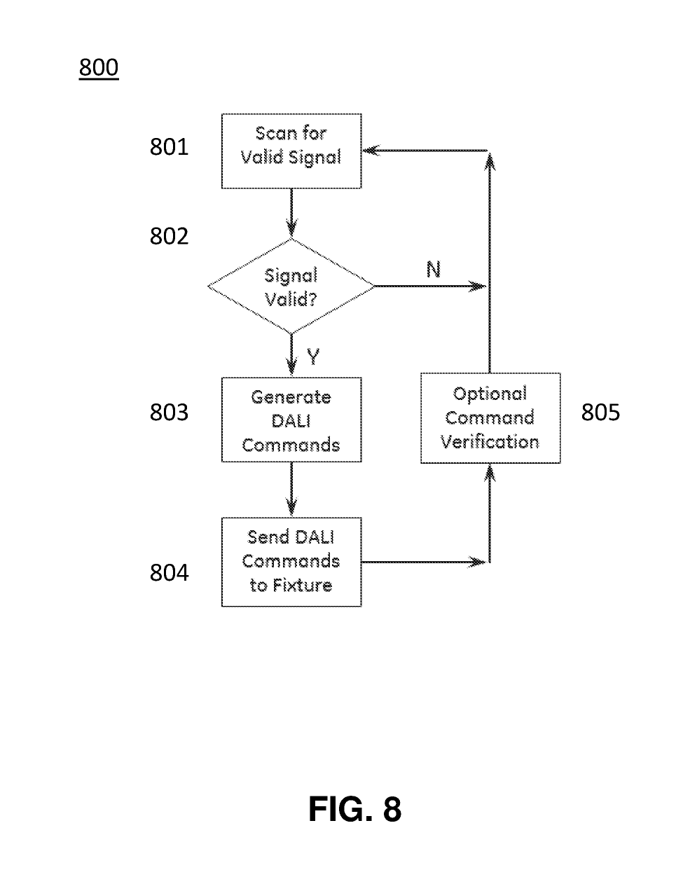

FIG. 8 depicts the flow chart of an embodiment of a method 800 of operation for a fixture which has been equipped with a response controller. The response controller's radio module scans to see if a wireless signal has been received for it to act upon at step 801. Once a valid signal has been received at step 802, the response controller generates a set of DALI commands 803 and communicates them to the DALI controlled fixture in step 804. Once completed, the system continues to scan for valid commands in step 801. The system can optionally send a signal back to the intelligent controller at step 805 via handshaking acknowledgement protocol in order to provide confirmation of the action requested.

Generally, some of the embodiments featured herein provide a lighting system that includes a first node associated with a first lighting fixture and a second node associated with a second lighting fixture. The first node may be communicatively coupled to a sensor. Further, the first node may be configured to fetch or receive data from the sensor, and, based on the data, the first node may communicate a command to the second node. The command may include an instruction to alter a light output at the second lighting fixture.

The first node may be configured to analyze the data to determine whether a condition is a met. For example, the first node may be configured to compare a measurement value extracted from the data with a threshold and generate the command when the measurement value exceeds or falls below the threshold.

The data may originate from a sensor selected from the group consisting of an image sensor, an accelerometer, a vibration sensor, a temperature sensor, a humidity sensor, an acoustic sensor and a light sensor. As previously mentioned, the sensor may or may not be co-located with a lighting fixture. In one specific example, the sensor can be a video camera.

The second node may be communicatively coupled to a power controller of the second lighting fixture, and the second node may be configured to instruct the power controller, according to a DALI protocol and based on the command, to alter the light output of the second lighting fixture.

The power controller may be configured to perform an operation selected from the group consisting of turning on the second lighting fixture, turning off the second lighting fixture, dimming a light beam of the second lighting fixture, and brightening the light beam of the second lighting fixture.

Another exemplary lighting system may feature a set of lighting fixtures in which each lighting fixture is associated with a control node and in which a specified control node associated with a specified lighting fixture is configured to instruct, based on sensor information, another control node associated with another lighting fixture to cause a change in the other lighting fixture's light output. The specified control node may be an intelligent control node whereas the other control node is a response controller node that is not configured to receive the senor information. In other words, the response controller node may have no connectivity to an image sensor, an accelerometer, a vibration sensor, a temperature sensor, a humidity sensor, or a light sensor.

The exemplary lighting systems featured herein are thus configured to perform autonomous lighting control. In other words, light output at one or more fixture in a lighting fixture network may be controlled without user intervention and based on measured (i.e., sensed) environmental conditions. Generally, a method executed by the hardware of the exemplary lighting systems can include receiving sensor information by a node associated with a second lighting fixture of the set. The method can further include communicating to a node associated with the first lighting fixture, based on the sensor information, a message configured to cause a power controller of the first lighting fixture to alter the light output at the first lighting fixture. The message may be sent wirelessly.

Generally, the method may include, prior to the communicating, determining, from the sensor information and by a processor of the node associated with the second lighting fixture, whether a condition has been met, and in response to the condition having been met communicating the message.

Typical systems may take the form of manual control or timer systems, which can be programmed to effect changes within the lighting system based upon a scheduled event. Certain types of lighting fixtures and control systems utilize ambient light sensors, such as Passive Infra-Red sensors (PIR sensors) which control individual fixtures or groups thereof by sensing the amount of ambient light or motion in the vicinity of a fixture and turning the fixture's power on or off as a result. Along with PIRs, there are a host of other control mechanisms possible, such as microwave sensors, radars and other passive and active sensing means. These systems tend to be have threshold settings within their control mechanisms which create an “on” or “off” signal based upon the trigger event and tend to be non-programmable and limited in their degree of ability to be adapted to a variety of applications and environments.

In contrast, systems in accordance with the embodiments of the present disclosure may comprise one or more intelligent sensing control nodes to provide autonomous operation. Such an intelligent control node can function as a point of central communications for a lighting network, and may possess the capability of determining the environmental or situational conditions of the network, and wirelessly adjusting the output of the other lighting fixtures in the network, either individually or as a group of one or more fixtures.

The intelligent control node is envisioned to include one or more sensors. In some embodiments, these sensors may comprise a video camera and associated processor in order to sense the environment and situations in the area around the lighting network. The processor may employ re-programmable analytics algorithms, and example of which may include sensing the number, quality or size of targets within the area of the fixtures before triggering the operation of the network fixtures. Such analytics algorithms may also include creating certain rules and operational guidelines so that a given sensing area of a sensor can be associated with a defined fixture (or defined fixtures) and provide lighting to those areas.

Along with the control node, the system typically further comprises nodal response controllers, which are attached to a plurality of lighting fixtures in the system. These nodal response controllers may receive a command signal (possibly wirelessly) from the control node and then provide signals to the fixture in response. These signals may include those necessary to dim the light source within the fixture, or turn off its power completely, or provide some other ancillary function within the fixture. The rationale behind altering the light output of a fixture is intended to improve the energy efficiency via reductions in energy consumption, improve safety in the area surrounding a fixture by increasing the illumination or altering its distribution so as to change its glare characteristics or possibly utilize the lighting fixtures in the network to signal conditions to people in the area by flashing or modulating the light output.

It is envisioned that the communications architecture within the system may comprise one or more radios for relatively low data rate, small packet transfer components. There exists several such radios, which can achieve robust small packet data communications over distances measured in kilometers. This disclosure is not intended to discuss the operational aspects of the radio hardware. It is typical that this radio sub-system will be common to both the control node and response controllers, and as such, certain common features may be included with it so as to optimize the cost and functional architecture of the system. An example of this would be to combine the power supply (e.g., an AC to DC convertor) as well as the lighting control architecture (e.g., DALI interface hardware/sub-system) along with the radio sub-system. In doing so, an optimal management of cost and economies of scale could be realized in a production environment.

As part of a network, a command and control protocol which can take advantage of the small packet communications hardware may be developed. A suitable command and control protocol may comprise: an addressing scheme to individually identify a lighting fixture; an addressing scheme to associate a fixture into a group of similarly controlled fixtures; and commands to turn power on and off, and/or to dim the fixture via adjustment of power levels.

Furthermore, there may be multiple light sources within the fixture, so it will also be necessary to create an identification scheme to address the control of these light sources within an individual fixture of group of fixtures. Further, data may be exchanged between a control node and a response controller, and therefore corresponding commands to request data and transmit data between the control and response nodes may be provided. This list is not meant to be all encompassing, and will certainly expand to incorporate other capabilities and features.

Together with the control node, the network of interconnected nodes can provide a long-range lighting control system. The response characteristics of the overall lighting network can be characterized by sensing a condition in the vicinity of the control node and generating the appropriate control response output for the lighting network.

Furthermore, in yet another use case, some embodiments may be structured as follows. One or more sensors may be an ambient acoustic sensor, (e.g., an audio microphone) or an ultrasonic sensor. A system featuring such sensors may be used along a roadway and configured for “highway sensing.” The exemplary system may use microphones rather than video cameras to sense traffic and weather conditions. Furthermore, in some alternate implementations, the exemplary system may include ultrasonic sensing, provided by an ultrasonic transducer (e.g., a speaker) and a receiver (e.g., a microphone) to detect motion and possibly count (i.e., estimate a degree of) traffic as it passes on the roadway.

In the latter implementation, the ultrasonic transducer may send out a high frequency tone (e.g., a 40,000 Hz) and look for Doppler shifts in the return signal. The ultrasonic transducer's receiver portion may be preferentially tuned for a high response in the 40,000 Hz range. These methods may be used because they can be more economical than video-based analytics, as in the previously described embodiments.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

1. A lighting system, comprising:
a first node associated with a first lighting fixture; and
a second node associated with a second lighting fixture, wherein the first node is communicatively coupled to a sensor, and wherein the first node is configured to (i) fetch or receive data from the sensor, and, based on the data, (ii) communicate a command to the second node, wherein the second node is not configured to receive the data from the sensor communicatively coupled to the first node,
and wherein the command is indicative of an instruction to alter a light output at the second lighting fixture.

2. The lighting system of claim 1, wherein the first node is configured to analyze the data to determine whether a condition is met.

3. The lighting system of claim 2, wherein the first node is configured to compare a measurement value extracted from the data with a predetermined threshold.

4. The lighting system of claim 3, wherein the first node is configured to generate the command when the measurement value exceeds or falls below the predetermined threshold.

5. The lighting system of claim 1, wherein the sensor is selected from the group consisting of an image sensor, an accelerometer, a vibration sensor, a temperature sensor, a humidity sensor, an ambient acoustic sensor, an ultrasonic sensor, and a light sensor.

6. The lighting system of claim 1, wherein the sensor is a video camera.

7. The lighting system of claim 1, wherein the second node is communicatively coupled to a power controller of the second lighting fixture.

8. The lighting system of claim 7, wherein the second node is configured to instruct the power controller, according to a Digital Addressable Lighting Interface (DALI) protocol and based on the command, to alter the light output of the second lighting fixture.

9. The lighting system of claim 8, wherein the power controller is configured to perform an operation selected from the group consisting of turning on the second lighting fixture, turning off the second lighting fixture, dimming a light beam of the second lighting fixture, and brightening the light beam of the second lighting fixture.

10. The lighting system of claim 1, wherein the first lighting fixture and the second lighting fixture are a part of a lighting fixture network of a parking lot.

11. The lighting system of claim 1, wherein the first lighting fixture and the second lighting fixture are a part of a lighting fixture network of a roadway.

12. A lighting system, comprising,
a set of lighting fixtures, wherein each lighting fixture is associated with a control node, and wherein a specified control node associated with a specified lighting fixture is configured to instruct, based on sensor information, another control node associated with another lighting fixture to cause a change in the another lighting fixture's light output, and wherein the another control node is not configured to receive the sensor information.

13. The lighting system of claim 12, wherein the specified control node is an intelligent control node.

14. The lighting system of claim 13, wherein the another control node is a response controller node, and wherein the response controller node is configured to issue commands to an associated lighting fixture based on commands received from the intelligent control node.

15. (canceled)

16. The lighting system of claim 12, wherein the sensor information is acquired from one of an image sensor, an accelerometer, a vibration sensor, a temperature sensor, a humidity sensor, an ambient acoustic sensor, an ultrasonic sensor, and a light sensor.

17. A method for use with a set of lighting fixtures, the method comprising:
autonomously altering a light output of a first lighting fixture of the set of lighting fixtures, wherein the altering comprises:
receiving sensor information by a node associated with a second lighting fixture of the set of lighting fixtures; and
communicating to a node associated with the first lighting fixture, based on the sensor information, a message configured to cause a power controller of the first lighting fixture to alter the light output at the first lighting fixture, wherein the node associated with the first lighting fixture is not configured to receive the sensor information.

18. The method of claim 17, wherein the sensor information comprises sensor data from at least one sensor selected from the group consisting of an image sensor, an accelerometer, a vibration sensor, a temperature sensor, a humidity sensor, an ambient acoustic sensor, an ultrasonic sensor, and a light sensor.

19. The method of claim 17, wherein the communicating is performed wirelessly.

20. The method of claim 17, further comprising, prior to the communicating, determining, from the sensor information and by a processor of the node associated with the second lighting fixture, whether a condition has been met, and in response to the condition having been met communicating the message.

21. The lighting system of claim 1, wherein the second node is not coupled to any sensors.
